(19) United States
(12) Patent Application Publication
(10) Pub. No.: US 2024/0272025 A1
(43) Pub. Date: Aug. 15, 2024

(54) SYSTEM FOR DETERMINING A TORQUE APPLIED BETWEEN TWO ROTATING MEMBERS

(71) Applicant: NTN EUROPE, Annecy (FR)

(72) Inventors: Alexandre Baudu, Annecy (FR); Siegfried Ruhland, Annecy (FR)

(21) Appl. No.: 18/427,718

(22) Filed: Jan. 30, 2024

(30) Foreign Application Priority Data
Feb. 9, 2023 (FR) FR-23 01225

(51) Int. Cl. G01L 3/10; G01L 5/22

(52) U.S. Cl. CPC G01L 3/104; G01L 5/225

(57) ABSTRACT

A system for determining a torque applied between two rotating members, including a test body having an inner bushing and an outer bushing concentrically connected by a deformable structure, and a device for determining an angle between the bushings which is a function of the applied torque, the deformable structure comprising a set of branches angularly distributed between the bushings, each of said branches extending in a direction between an inner end and an outer end, said direction forming an angle with the diametral direction passing through said inner end, each of the branches having a foot section extending from the inner end to said direction and a head section extending from the direction to the outer end, the sections forming a convex bend for the foot section and a concave bend for the head section.

The invention concerns a system for determining a torque applied between two rotating members in one direction around a geometric axis of rotation.

In particular, the members can be integrated into a transmission of a motor torque to a vehicle, for example between the electric motor or crankset and the mechanical transmission of an electrically-assisted bicycle.

For this purpose, it is known to use a test body having an inner bushing secured in rotation with means for coupling said test body to a first one of the members, and an outer bushing extending around the inner bushing and having means for coupling said test body to the second one of the members, said bushings being connected concentrically around the axis of rotation by a deformable structure which is arranged to transmit the torque between the members while allowing an angular displacement between said bushings as a function of the torque applied between the members.

Such a test body can be instrumented with an encoder by equipping each of the bushings with a ring carrying a respectively inner and outer magnetic track which is able to emit a periodic signal representative of the rotational displacement of the corresponding bushing. In particular, each of the tracks has a succession of pairs of North and South poles to form a multipolar magnetic track delivering a pseudo-sinusoidal magnetic signal.

The determination system then comprises a sensor with a first—respectively a second—pattern of sensing elements arranged at a reading distance from the inner track—respectively the outer track—to form a signal representative of the angular position of the corresponding ring.

Documents FR-2 816 051, FR-2 821 931 and FR-2 862 382 describe the use of a device for comparing such signals which is able to determine an angular deviation between the portions, and therefore the torque applied in that it induces said angle by twisting the deformable structure.

In some applications, such as the transmission of an electrically-assisted bicycle, the space available for implementing the test body is severely limited. As a result, it is necessary to design test bodies with reduced overall dimensions, particularly radially, which further constrains the design of the deformable structure.

This constraint is all the more critical as the deformation of the structure must be limited to avoid feeling the angle of twist in the transmission, while being extremely reliable both in terms of the angular deflection induced and in terms of its mechanical strength. In particular, the deformable structure may have to undergo a deflection of the order of a few degrees of angle while resisting a torque of the order of 250 Nm.

The aim of the invention is to improve the prior art by proposing, in particular, a system of which the test body is compact while being mechanically resistant and reliable in terms of the angle of deflection used to determine the torque applied.

To this end, the invention proposes a system for determining a torque applied between two rotating members in one direction about a geometric axis of rotation, said system comprising:
a test body having an inner bushing secured in rotation with means for coupling said test body to a first one of the members, and an outer bushing extending around the inner bushing and having means for coupling said test body to the second one of the members, said bushings being connected concentrically around the axis by a deformable structure which is arranged to transmit the torque between the members while allowing an angular deflection between said bushings as a function of the torque applied between said members;
a device for determining an angle between the bushings as a function of the torque applied;
   the deformable structure comprising a set of branches angularly distributed between the bushings, each of said branches extending along a direction D between an inner end and an outer end, said direction D forming an angle INCb with the diametral direction D_{d} passing through said inner end, each of said branches having a foot section extending from the inner end to the direction D and a head section extending from said direction D to the outer end, said sections forming a bend respectively convex for the foot section and concave for the head section.

Further objects and advantages of the invention will become apparent from the following description, made with reference to the appended figures, in which:

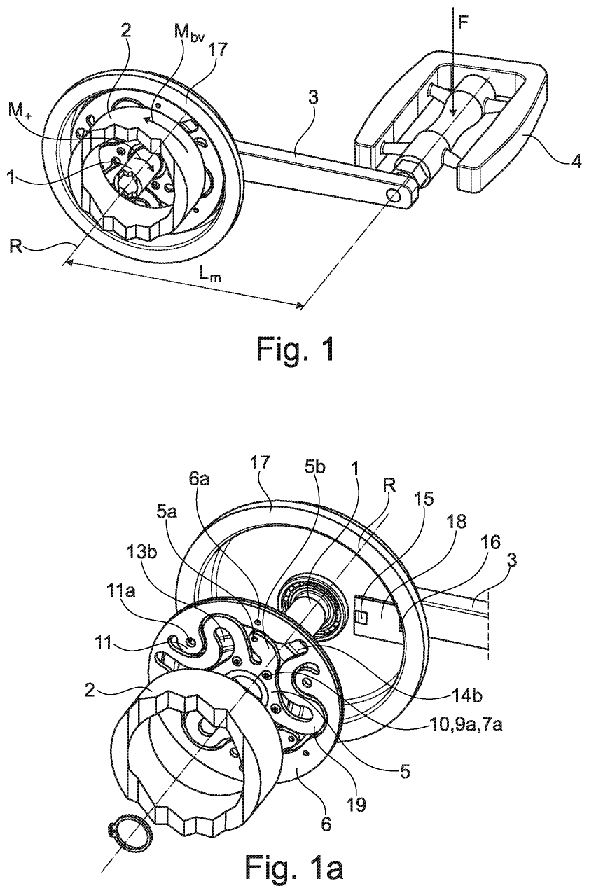

FIG. 1 is a partial cross-sectional perspective view of the crankset of an electrically-assisted bicycle fitted with a torque determination system according to the invention,

FIG. 1a is an exploded zoomed view of FIG. 1, showing in particular the mounting of the test body,

FIG. 1b is a longitudinal section view of FIG. 1a;

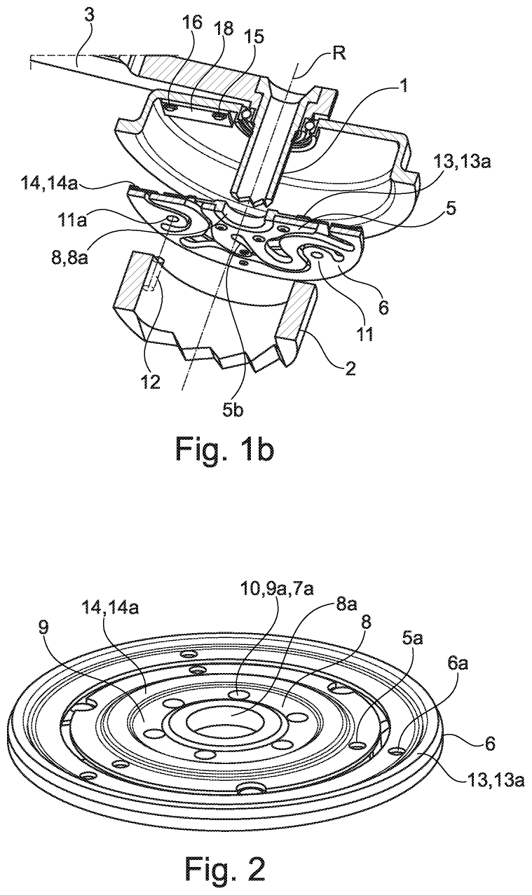

FIG. 2 is a top perspective view of the test body shown in FIG. 1,

FIG. 2a being a front view of said test body without any encoder,

FIG. 2b being a longitudinal section view of FIG. 2a;

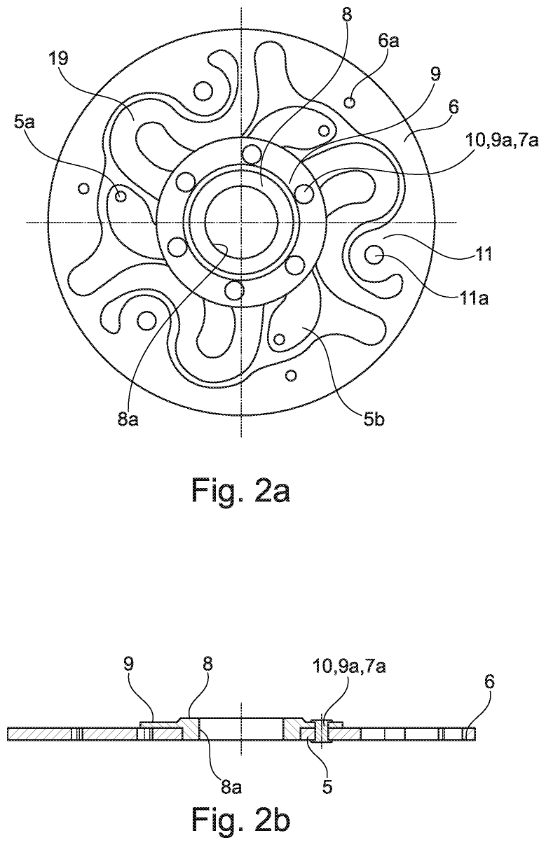

FIG. 3 is a perspective view of FIG. 2a in which the nut has been removed,

FIG. 3a is a front view of FIG. 3;

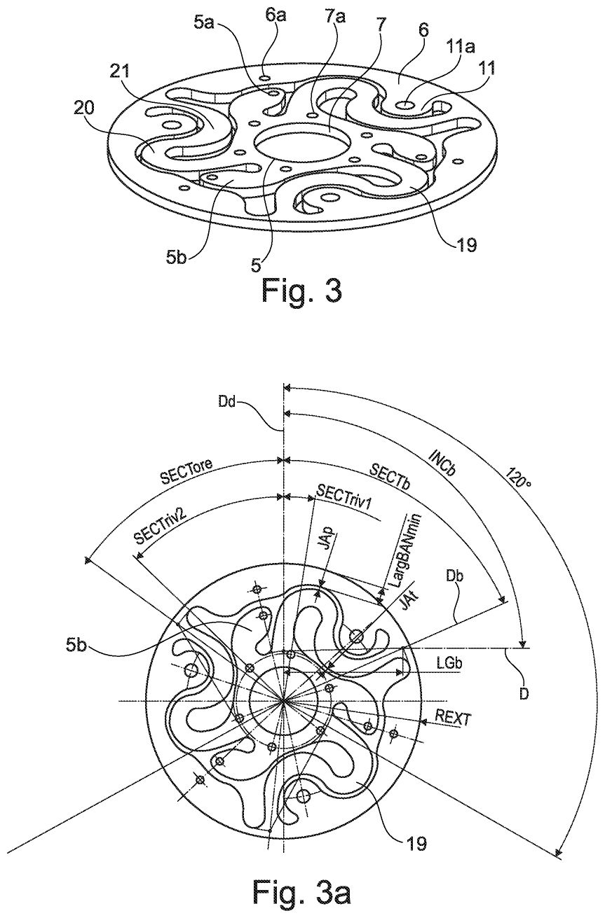

FIG. 4 shows a front view of a branch in the test body of FIG. 3a;

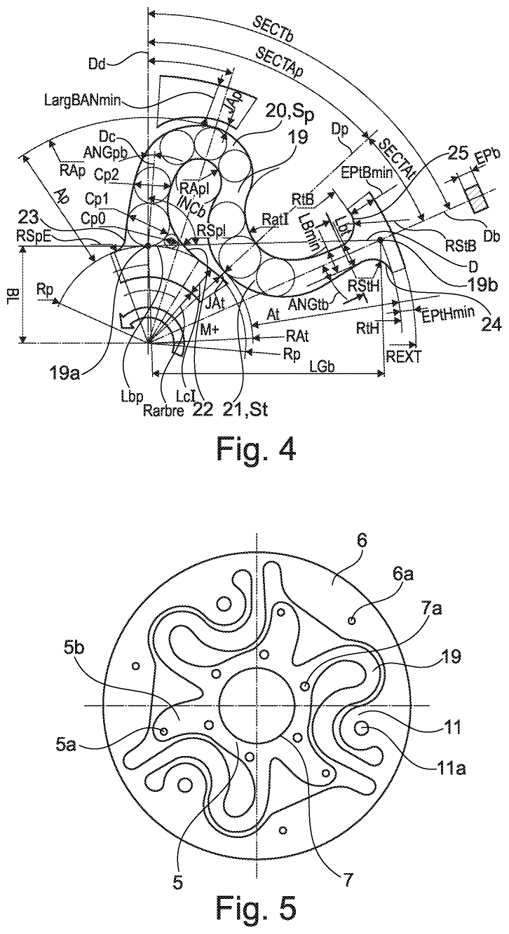

FIG. 5 and

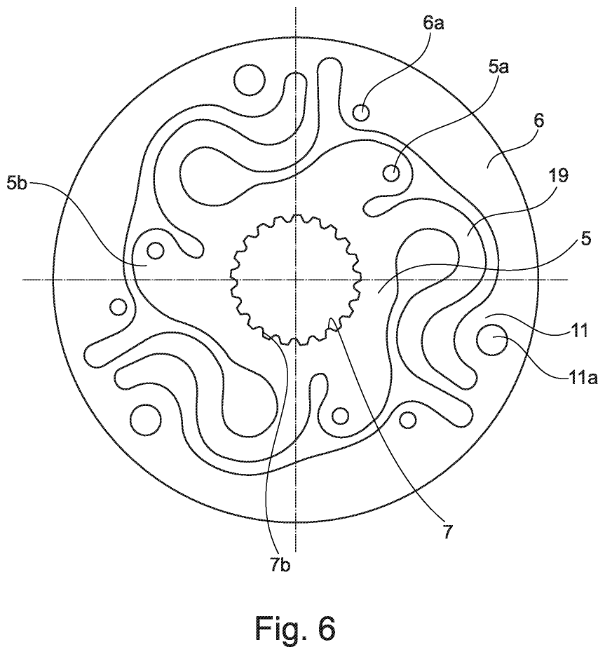

FIG. 6 are front views of a test body according to a respective variant of embodiment of the invention.

In relation with these figures, we describe hereinbelow a system for determining a torque applied between two rotating members 1, 2 in one direction about a geometric axis of rotation R.

In this description, spatial positioning terms are taken in reference to the axis R of rotation. In particular, the terms “inner” and “outer” refer to an arrangement respectively close to and at a distance from this axis R, and the terms “axial” and “radial” refer to an arrangement respectively following this axis R and moving away from or towards it.

In particular, the system enables the determination of a torque applied between two members 1, 2 integrated in a transmission of a motor torque to a vehicle, for example between the electric motor or the crankset and the mechanical transmission of an electrically assisted bicycle.

FIG. 1 shows a crankset of an electrically assisted bicycle comprising a crank 3 equipped with a pedal 4, said crank being mounted on a shaft driven in rotation along the axis R to form a member 1 for applying a pedaling torque M₊ in the pedaling direction.

The system comprises a test body which enables the pedaling torque M₊ to be transmitted to the other member 2, which in the figures is shown in the form of a sleeve, for example a satellite carrier of a planetary gear train of a motorized gearbox, exerting a torque Mbv.

In this application, the pedaling force F at the end of pedal 4 to be considered according to standard EN15194: 2017 is 1,500 N which, with a crank length Lm of 165 mm, generates a torque M₊ of the order of 250 Nm. In particular, the torque to be transmitted by the test body is only in one direction of rotation (that represented by M₊ on the figures), as the other direction corresponds to the freewheel of the bicycle.

The test body has an inner bushing 5 secured in rotation to means for coupling said test body to the first member 1, and an outer bushing 6 extending around the inner bushing 5 and having means for coupling said test body to the second member 2.

In relation to the figures, the inner bushing 5 has a bore 7 fitted with means of coupling to the shaft, for example in the form of a thread or splines.

In relation to FIGS. 1 to 5, a nut 8 for coupling the test body with the first member 1 is attached by being fixed in the bore 7, said nut 8 having a bore 8a allowing coupling, for example by being equipped with a thread or splines.

In the embodiment shown, the nut 8 is held in the bore 7 by riveting. To do this, the nut 8 has a flange 9 in which holes 9a are formed, the edge of the bore 7 being provided with complementary holes 7a enabling said nut to be riveted in place by means of rivets 10.

In relation to FIG. 6, the bore 7 is directly provided with splines 7b for coupling with the shaft of the first member 1.

With regard to the coupling to the other member 2, the embodiments shown provide that the outer bushing 6 has at least one radial lobe 11 which is equipped with a means of securing the said outer bushing to the sleeve. In particular, three lobes 11 at 120° are provided, each of which having a hole 11a for attachment by a pin 12 or by screwing into a complementary hole in the sleeve. Alternatively, the outer bushing 6, and in particular its periphery, may have geometric means of meshing with the second member 2.

The bushings 5, 6 are connected concentrically around the axis R by a deformable structure which is arranged to transmit torque between the members 1, 2 while allowing angular deflection between said bushings as a function of the torque applied between said members.

In particular, the torque resulting from the pedal torque M₊ applied to the inner bushing 5 and from the torque Mbv applied by the sleeve to the outer bushing 6 induces a torsion between bushings 5, 6 and therefore a relative angular displacement of said bushings according to a torsion angle which is a function of said torque.

The system includes a device for determining the angle between the bushings 5, 6 which, in particular by taking into account the stiffness of the deformable structure, is a function of the torque applied.

According to one embodiment, the determination device comprises:
an encoder produced by equipping each of the bushings 5, 6 with a ring 13, 14 carrying respectively an inner magnetic track 13a and an outer magnetic track 14a, which is able to emit a periodic signal representative of the rotational displacement of the corresponding bushing 5, 6;
a sensor comprising a first 15—respectively a second 16—pattern of sensing elements arranged at a reading distance from the inner track 13a
respectively the outer track 14a—to form a signal representative of the angular position of the corresponding ring 13, 14;
a device for comparing the signals delivered by the sensor, said device being able to determine an angle between the bushings 5, 6 which is a function of the torque applied.

In relation to the figures, the crankset axle is rotatably mounted in a housing 17 on which the sensor is implanted with patterns 15, 16 at reading distance from the corresponding tracks 13a, 14a.

In one embodiment, each of the rings 13, 14 is carried by a respective inner 13b and outer 14b frame, the inner 5—respectively outer 6—bushing having means for securing the inner 13b—respectively outer 14b—frame to it.

In particular, each of the bushings 5, 6 has holes 5a, 6a for fastening the frames 13b, 14b, in particular by screwing or riveting. In relation to the figures, three fixing holes 5a, 6a are arranged at 120° to one another.

In one embodiment, a succession of pairs of North and South poles are magnetized on a respective ring 13, 14 to form a multipolar magnetic track 13a, 14a capable of emitting a pseudo-sinusoidal magnetic signal.

Rings 13, 14 may comprise an annular matrix, for example made from a plastic or elastomer material, in which magnetic particles, in particular ferrite particles or rare-earth particles such as NdFeB, are dispersed, said particles being magnetized to form magnetic tracks 13a, 14a.

Each pattern 15, 16 may comprise at least two sensing elements, in particular a plurality of aligned sensing elements, as described in documents FR-2 792 403, EP-2 602 593 and EP-2 602 594.

The sensing elements can be based on a magnetoresistive material whose resistance varies according to the magnetic signal of the track 13a, 14a to be detected, for example of the AMR, TMR or GMR type, or a Hall-effect probe.

In one embodiment, the angular position can be determined incrementally by means of the signal emitted by a magnetic track 13a, 14a. In another embodiment, the angular position can be determined absolutely, i.e. relative to a reference position, by providing a secondary magnetic track or specific coding on the ring 13, 14.

The system also includes a device for comparing the signals delivered by the sensor, said device being able to determine an angle between the bushings 5, 6 which is a function of the torque applied. In relation to the figures, the sensor comprises a card 18 on which patterns 15, 16 of sensing elements are implanted in an electronic circuit.

In one embodiment, the sensors deliver quadrature incremental square-wave signals, the comparison device comprising counting means indicating the angular position of each of the rings 13, 14 and subtraction means for calculating the difference between said angular positions, in particular as described in documents FR-2 816 051, FR-2 821 931 and FR-2 862 382.

The deformable structure comprises a set of branches 19 angularly distributed between the bushings 5, 6. In particular, the branches 19 and the bushings 5, 6 are formed in a single piece, for example by cutting with a wire machine or by stamping a blank of metallic material.

Each of the branches 19 extends in a direction D between an inner end 19a and an outer end 19b, said direction forming an angle INCb with the diametral direction D_{d} passing through said inner end, each of said branches having a foot section Sₚ extending from the inner end 19a to the direction D and a head section Sₜ extending from said direction D to the outer end 19b, said sections forming a bend respectively convex 20 for the foot section Sₚ and concave 21 for the head section Sₜ.

As shown in the figures, for a torque M₊ applied to the inner bushing 5 in a counter-clockwise direction, the branches 19 are inclined to the right. The choice of the angle of inclination INCb depends on the maximum torque to be transmitted and on the width of the branches 19.

The inclination of the branches 19 in combination with their S-shaped geometric conformation with two bends 20, 21 makes it possible to satisfy the radial space requirement of the test body, for example in relation to an outer bushing 6 with a REXT radius of less than 50 mm, while increasing the length LGb of the branches 19 in order to reduce their stiffness, in particular by maximizing the amplitude of the bends 20, 21.

In particular, the branches 19 function like a leaf spring and, in order to obtain a flexible spring while controlling maximum stresses, it is the length of the branches 19 that is important. With the inclination, a purely tensile component is superimposed on the bending at the connection between the branch 19 and the bushings 5, 6, as the branch 19 lengthens when the outer bushing 6 rotates.

This S-shape conformation allows the branches 19 to be inclined significantly, which increases the lever arm BL and therefore reduces the forces in the branches 19. In particular, for a design with three branches 19, the angle INCb can advantageously be between 80° and 100°, for example in the order of 90°.

Furthermore, an S-shaped branch 19 can have a large thickness EPb, for example of the order of 4 mm, and be subjected to reduced stresses, so as to be able to limit its buckling and therefore not constrain the operating direction of rotation of the test body. In relation to FIG. 5, the branches 19 are refined in comparison with the design shown in FIGS. 1 to 4, in order to increase the angular deflection of the bushings 5, 6 under torque.

Advantageously, the branch length LGb of each of the branches 19 measured between the inner end 19a and the outer end 19b can be greater, in particular greater than 120%, of the difference between the head radius RtH passing through the outer end 19b and the foot radius Rp passing through the inner end 19a.

Furthermore, to maximize the length of branches 19, the outer radius REXT of the outer bushing 6 must be as large as possible within the available space, and the head radius RtH must be as close as possible to said outer radius REXT while maintaining a minimum cross-section between the branch head 19 and said outer radius. In one embodiment, the radial compactness of the test body may be such that: 1.05<REXT/RtH<1.15.

Each of the branches 19 extends over a branch angular sector SECTb between the diametral direction D_{d} and a diametral direction D_{b} passing through the outer end 19b, said branch angular sector being comprised between 50° and 70°.

According to the embodiment shown, the bends 20, 21 have a radius of curvature RApl, RAtl, the radius of curvature RApl of the bend 20 of the foot section Sₚ being smaller than the radius of curvature RAtl of the bend 21 of the head section Sₜ.

In addition, the foot section Sₚ extends over a foot angular sector SECTAp between the diametral direction D_{d} and a diametral direction Dₚ passing through the center of the circle defined by the radius of curvature RAtl of the bend 21 of the head section Sₜ, the head section Sₜ extending over a head angular sector SECTAt between the diametral direction Dₚ and the diametral direction D_{b} passing through the outer end 19b, said head angular sector being smaller than said foot angular sector.

Furthermore, the radial amplitude Ap of the foot section Sₚ along the radius RAp in which the apex of the bend 20 is inscribed can be maximized, in particular by providing a reduced clearance JAp between said bend and the outer bushing 6.

In relation to the figures, each of the 19 branches has:
a foot extending in width Lbp around the inner end 19a, said foot being connected to the inner bushing 5 by two foot surfaces respectively upstream 22 and downstream 23 in the direction of rotation; and
a head extending in width Lbt around the outer end 19b, said head being connected to the outer bushing 6 by two head surfaces, respectively upstream 24 and downstream 25 in the direction of rotation.

In addition to the inclination of the branches 19, the heads and/or feet can be connected asymmetrically to the corresponding bushing 5, 6. In particular, as with the inclination, the asymmetry is possible because there is only one direction of rotation in which torque is to be transmitted.

At the foot of the branch 19 and at the head of the branch 19, we typically have stress concentrations due to the bending part of branches 19, which can be smoothed out thanks to the asymmetry that is generated by a radial offset of the output radius on either side of the feet and heads.

In particular, the upstream head surface 24 is inscribed in a radius RtH which is greater than a radius RtB in which the downstream head surface 25 is inscribed, the outer end 19b of the branch 19 being arranged along the radius RtH by defining a respective minimum thickness EPtHmin and EPtBmin, respectively at the upstream head surface 24 and the downstream head surface 25. Advantageously, the thickness EPtHmin is less than the thickness EPtBmin to maximize the amplitude At between the top of the bend 21 and the outer end 19b.

Furthermore, the upstream 24 and downstream 25 head surfaces each extend along a radius RStH, RStB, while the upstream 22 and downstream 23 foot surfaces each extend along a radius RSpl, RSpE. In relation to FIG. 4, the radius RSpl is greater than the radius RSpE, the radii RStH and RStB being of similar value.

Advantageously, the width of the branches 19 may not be constant, in particular by being scalable, in order to be able to harmonize the stresses within said branches, in particular in relation to the bending and tensile stresses to which they are subjected.

In relation to FIG. 4, each of the branches 19 has a portion for connection with the outer bushing 6, said portion having a downstream face extending in a radial direction and an upstream face forming an angle ANGtb with said radial direction, in order to reduce stresses by defining a minimum branch 19 width Lbmin.

Furthermore, each of the branches 19 extends from the foot into an envelope formed by a superposition of circles comprising a first circle of diameter Cp1 tangent to the inner end 19a and a second circle of diameter Cp2, said diameter Cp1 being greater than the diameter Cp2.

In addition, the direction D_{c} passing through the centers of the circles of diameter Cp1 and Cp2 is inclined by an angle ANGpb with respect to the diametral direction D_{d}, for example by an angle of +/−5° in order to be able to produce the branches 19 with a first circle of large diameter Cp1 in order to reduce stresses.

In relation to FIG. 3a, three branches 19 are each arranged on an angular sector SECTb, said branches being spaced two by two by an angular sector SECTore which is complementary to 120° of the angle SECTb.

In the embodiments shown, the inner bushing 5 has three lugs 5b which extend between the bushings 5, 6 in the SECTore angular sector, each of said lugs having a fastening hole 5a and the fastening holes 6a also being arranged in the SECTore angular sectors.

Each of the lobes 11 is arranged in an angular sector SECTb of branch 19, said lobe extending inside the bend 21 of the head section Sₜ. In particular, the lobe 11 has a radius of curvature analogous to the radius of curvature RAtl of the bend 21 so as to form a reduced clearance JAp with said bend.

This design saves space and, in this position, there is only very little deformation under load, so that relative movement in the clearance JAp is reduced to a minimum, avoiding wear phenomena.

In the embodiment shown, the clearance JAp between the outer bushing 6 and the branch 19 is substantially constant from the lobe 11 to the bend 20, so as to define a width LargBANmin of the bushing 6 which is sufficient to limit its deformation opposite said bend.

In addition, the clearance JAt between the bend 21 and the inner bushing 5, i.e. the difference between the radius RAt in which the bend 21 is circumscribed and the radius Rp of the facing inner bushing 5, is also reduced while maintaining a thickness Lcl, i.e. the difference between the radius Rp and the radius Rarbre of the first member 1, which is sufficient for the strength of said bushing, in particular by ensuring the rigidity of the embedding of the branch 19 foot.

In relation to FIG. 3a, the edge of bore 7 of the inner bushing 5 is provided with three sets of two complementary holes 7a for riveting the nut 8 by means of rivets 10, said sets being spaced at 120°.

Insofar as the inner bushing 5 is relatively flexible compared to the branches 19, it contributes to the flexibility of the test body by being able to induce micromovements between the nut 8 and said inner bushing.

To avoid over-stressing at the riveting areas, the first rivet 10 of a set is positioned in a sector where these possible movements are the smallest, i.e. close to a branch 19 foot, in particular over an angular sector SECTriv1 of less than 15° with the diametral direction D_{d}.

The second rivet 10 of a set can be positioned in an angular sector SECTriv2 included in the angular sector SECTore, in particular by being of the order of 45° with respect to the diametral direction D_{d}.

1. A system for determining a torque applied between two rotating members in one direction about a geometric axis of rotation (R), said system comprising:
a test body having an inner bushing secured in rotation with means for coupling said test body to a first one of the members, and an outer bushing extending around the inner bushing and having means for coupling said test body to the second one of the members, said bushings being connected concentrically around the axis (R) by a deformable structure which is arranged to transmit torque between the members while allowing angular deflection between said bushings as a function of the torque applied between said members;
a device for determining an angle between the bushings as a function of the torque applied;
the deformable structure including a set of branches angularly distributed between the bushings, each of said branches extending along a direction D between an inner end and an outer end, said direction D forming an angle INCb with the diametral direction D_{d} passing through said inner end, each of said branches having a foot section (Sₚ) extending from the inner end to the direction D and a head section (Sₜ) extending from said direction D to the outer end, said sections forming respectively a convex bend for the foot section (Sₚ) and a concave bend for the head section (Sₜ).

2. The torque determination system according to claim 1, wherein the angle INCb is between 80° and 100°.

3. The torque determination system according to claim 1, wherein each of the branches extends over a branch angular sector SECTb between the diametral direction D_{d} and a diametral direction D_{b} passing through the outer end, said branch angular sector being between 50° and 70°.

4. The torque determination system according to claim 1, the bends having a radius of curvature RApl, RAtl, the radius of curvature RApl of the bend of the foot section (Sₚ) being smaller than the radius of curvature RAtl of the bend of the head section (Sₜ).

5. The torque determination system according to claim 1, the foot section (Sₚ) extending over a foot angular sector SECTAp between the diametral direction D_{d} and a diametral direction Dₚ passing through the center of the circle defined by a radius of curvature RAtl of the bend of the head section (Sₜ), said head section extending over a head angular sector SECTAt between the diametral direction Dₚ and a diametral direction D_{b} passing through the outer end, said head angular sector being smaller than said foot angular sector.

6. The torque determination system according to claim 1, the branch length LGb of each of the branches being greater than 120% of the difference between the head radius RtH passing through the outer end and the foot radius Rp passing through the inner end.

7. The torque determination system according to claim 1, each of the branches having a foot extending over a width Lbp around the inner end, said foot being connected to the inner bushing by two foot surfaces respectively upstream and downstream in the direction of rotation.

8. The torque determination system according to claim 7, wherein each of the branches extends from the foot into an envelope formed by a superposition of circles comprising a first circle of diameter Cp1 tangent to the inner end and a second circle of diameter Cp2, said diameter Cp1 being greater than the diameter Cp2.

9. The torque determination system according to claim 8, the direction D_{c} passing through the centers of the circles of diameter Cp1 and Cp2 is inclined by an angle ANGpb with respect to the diametral direction Do.

10. The torque determination system according to claim 1, each of the branches having a head extending over a width Lbt around the outer end, said head being connected to the outer bushing by two head surfaces respectively upstream and downstream in the direction of rotation.

11. The torque determination system according to claim 10, the upstream head surface being inscribed in a radius RtH which is greater than a radius RtB in which the downstream head surface is inscribed.

12. The torque determination system according to claim 1, each of the branches having a portion for connection with the outer bushing, said portion having a downstream face extending in a radial direction and an upstream face forming an angle ANGtb with said radial direction.

13. The torque determination system according to claim 1, the outer bushing having at least one radial lobe which extends inside the bend of the head section (Sₜ), said lobe being equipped with means for securing the outer bushing to the second member.

14. The torque determination system according to claim 13, the lobe having a radius of curvature analogous to a radius of curvature RAtl of the bend of the head section (Sₜ) so as to form a reduced clearance JAp with said bend.

15. The torque determination system according to claim 1, wherein the determination device comprises:
an encoder produced by equipping each of the bushings with a ring carrying a respective inner and outer magnetic track which is able to emit a periodic signal representative of the rotational displacement of the corresponding bushing;
a sensor comprising a first—respectively a second—pattern of sensing elements arranged at a reading distance from the inner track—respectively the outer track—to form a signal representative of the angular position of the corresponding ring;
a device for comparing the signals delivered by the sensor, said device being able to determine an angle between the bushings which is a function of the torque applied.
